(19) United States
(12) Patent Application Publication
(10) Pub. No.: US 2004/0167719 A1
(43) Pub. Date: Aug. 26, 2004

(54) System and method for evaluating the cost-effectiveness of providing growth hormone replacement therapy

(76) Inventors: Jonathan Jones, Tadworth (GB); Adrian Griffin, Tadworth (GB)

Correspondence Address: DINSMORE & SHOHL, LLP, 1900 CHEMED CENTER, 255 EAST FIFTH STREET, CINCINNATI, OH, 45202, US

(21) Appl. No.: 10/635,258

(22) Filed: Aug. 6, 2003

Related U.S. Application Data
(60) Provisional application No. 60/401,475, filed on Aug. 6, 2002.

(51) Int. Cl. G06F 19/00

(52) U.S. Cl. 702/19

(57) ABSTRACT

Systems and methods of determining a plurality of cost/utility estimates are used to evaluate the cost effectiveness of providing growth hormone replacement therapy to individuals having growth hormone deficiency. In an exemplary embodiment of the invention, the system has executable instructions for predicting the development of one or more morbidities in an individual having growth hormone deficiency over a simulated life cycle; and for determining and outputting a plurality of cost/utility estimates which may be used by a researcher to evaluate the cost-effectiveness of providing growth hormone replacement therapy.

### RELATED APPLICATIONS

The present application claims priority under 35 U.S.C. § 119 of U.S. Application Serial No. 60/401,475 filed Aug. 6, 2002.

### FIELD OF THE INVENTION

The present invention relates to systems and methods for evaluating the cost-effectiveness of growth hormone replacement therapy. More specifically, the present invention relates to systems and methods for determining and outputting a plurality of cost/utility estimates which may be used to evaluate the cost-effectiveness of providing growth hormone replacement therapy to individuals having growth hormone deficiency.

### BACKGROUND OF THE INVENTION

Large pharmaceutical companies, such as Pharmacia AB, often develop medications or drugs for the purpose of treating individuals having specific diseases such as growth hormone deficiency. As part of the development process, these companies typically conduct extensive research into the specific disease and generate and learn much knowledge relating to the disease. These companies, however, find it difficult to share this research and knowledge with respect to the particular ailment with third party organizations such as hospitals, insurance companies or budget holders. In particular, it is difficult for pharmaceutical companies to show the possible impact of their developed medication or treatment as it might impact the economics of the third party organization. Accordingly, it would be advantageous to have a system and method that was adaptable to be used on various computer systems to allow the research to be shared with others.

Additionally, as part of the research and development process, it is often times difficult for the large pharmaceutical companies to predict how many individuals having a particular disease would not only try a medication specifically designed to treat such a disease, but would also predict how many individuals would use the medication over the long-term. As a result, it would be advantageous to have a system and method that made these predictions.

Finally, it is difficult for these companies to determine a cost/utility estimate associated with providing a medication or treatment to the individuals afflicted with the particular ailment and it is also difficult for these companies to target research to a specific sub-group having the disease. Accordingly, it would be advantageous to provide a system and method that determined a plurality of cost/utility estimates that could be easily modified to research and target specific sub-groups of individuals having a particular disease such as growth hormone deficiency.

### SUMMARY OF THE INVENTION

One embodiment of the invention is directed to a method of determining a plurality of cost/utility estimates for evaluating the cost effectiveness of providing growth hormone replacement therapy to an individual having growth hormone deficiency. The method comprises the steps of identifying one or more morbidities associated with growth hormone deficiency; predicting the development of the one or more morbidities in an individual being treated with growth hormone replacement therapy over a simulated life cycle; estimating a cost associated with providing growth hormone replacement therapy and with treating the predicted developed one or more morbidities in the individual being treated with growth hormone replacement therapy over the simulated life cycle; estimating a utility associated with being treated with growth hormone replacement therapy; predicting the development of the one or more morbidities in an individual not being treated with growth hormone replacement therapy over a simulated life cycle; estimating a cost associated with treating the predicted developed one or more morbidities in the individual not being treated with growth hormone replacement therapy over the simulated life cycle; and estimating a utility with not being treated with growth hormone replacement therapy.

Another embodiment of the invention is directed to a computer-readable medium containing instructions for outputting a plurality of cost/utility estimates for evaluating the cost effectiveness of providing growth hormone replacement therapy to an individual having growth hormone deficiency. The computer-readable medium comprises instructions being operable to predict the development of one or more predetermined morbidities in an individual being treated with growth hormone replacement therapy over a simulated life cycle; estimate a cost associated with providing growth hormone replacement therapy and with treating the predicted developed one or more morbidities in the individual being treated with growth hormone replacement therapy over the simulated life cycle; estimate a utility associated with being treated with growth hormone replacement therapy; predict the development of the one or more predetermined morbidities in an individual not being treated with growth hormone replacement therapy over a simulated life cycle; estimate a cost associated with treating the predicted developed one or more morbidities in the individual not being treated with growth hormone replacement therapy over the simulated life cycle; estimate a utility associated with being treated with growth hormone replacement therapy; and output the estimated cost and estimated utility associated with the individual being treated with growth hormone replacement therapy and the estimated cost and estimated utility associated with the individual not being treated with growth hormone replacement therapy.

Yet another embodiment of the invention is a system for outputting a plurality of cost/utility estimates for evaluating the cost effectiveness of providing growth hormone replacement therapy to an individual having growth hormone deficiency. In this embodiment of the invention, the system comprises a database and a computer system. The database has data identifying one or more morbidities associated with growth hormone deficiency; data identifying a probability of developing the one or more morbidities; data identifying a cost associated with treating the one or more morbidities; data identifying a cost associated with providing growth hormone treatment therapy; and data identifying a utility associated with treating the one or more morbidities. The computer system comprises executable instructions in communication with the database, which is configured to predict the development of one or more morbidities over a simulated life cycle. The computer system further comprises executable instructions configured to output the costs and utilities associated with treating the predicted morbidities developed by the individual.

Objects, advantages and novel features of the present invention will become apparent to those skilled in the art from the following detailed description, which is simply, by way of illustration, various modes contemplated for carrying out the invention. As will be realized, the invention is capable of other different aspects all without departing from the invention. Accordingly, the drawings and descriptions are illustrative in nature and not restrictive.

### BRIEF DESCRIPTION OF THE DRAWINGS

While the specification concludes with claims particularly pointing out and distinctly claiming the present invention, it is believed that the same will be better understood from the following description, taken in conjunction with the accompanying drawings, in which:

FIG. 1 depicts an exemplary schematic embodiment of a system for implementing one embodiment of the present invention;

FIG. 2 depicts an exemplary flow diagram of a method for predicting the development of one or more morbidities in an individual having growth hormone deficiency over a simulated life cycle; and

FIG. 3 depicts an exemplary flow diagram of a method of determining and outputting a plurality of cost/utility estimates which may be used to evaluate the cost- effectiveness of providing growth hormone replacement therapy.

### DETAILED DESCRIPTION OF EXEMPLARY EMBODIMENTS

Reference will now be made in detail to various embodiments of the invention, various examples of which are illustrated in the accompanying drawings, wherein like numerals indicate corresponding elements throughout the views.

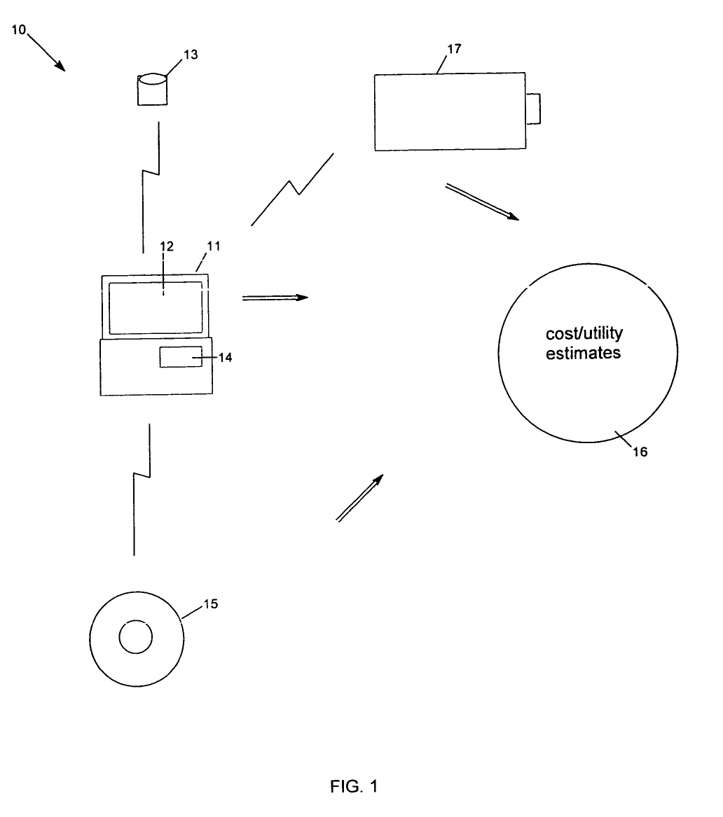

FIG. 1 depicts an exemplary schematic embodiment of a system 10 for implementing one embodiment of the present invention. In general, and as will be defined in more detail, the system 10 of the present invention is configured to determine and output a plurality of cost/utility estimates which may be used by a researcher to evaluate the cost-effectiveness of providing a growth hormone replacement drug, such as Genotropin® as available from Pharmacia AB, to individuals having growth hormone deficiency. As used throughout the specification, the term “utility” is intended to be a quantified numeric health measure that represents a quality of life estimate of an individual having growth hormone deficiency.

In an exemplary embodiment of the present invention, the system 10 may comprise a computer system 11 having components such as, but not limited to, a monitor having a display screen 12, keyboard, CPU, memory, CD ROM drive 14, random number generator (not shown) or any other component a user may desire. The computer system 11 may also comprise a database or be in communication with a database 13, for example, via the Internet or through any other communication medium. In an exemplary embodiment of the invention, the computer system 11 may comprise executable instructions, or may be configured to read a CD ROM 15 or other compatible computer readable medium containing executable instructions configured to determine an output 16 comprising a plurality of cost/utility estimates that may be used by a researcher to evaluate the cost effectiveness of providing growth hormone replacement therapy to individuals having growth hormone deficiency. The output 16 of the computer system 11 may be to the CD ROM 15 configured to interface with drive 14, through the display screen 12, and/or through a printer 17 in communication with the system 11.

The database 13 of FIG. 1 is configured to comprise data and other information relating to individuals having growth hormone deficiency. In particular, third parties such as doctors may collect data relating to individuals having growth hormone deficiency. The collected data may be stored as data in the database 13, which may be studied for medical and treatment purposes. The data may be collected from individuals having growth hormone deficiency via surveys, questionnaires and the like. The data may contain information concerning individuals, for example, including, but not limited to, age, height, weight, sex, total cholesterol, high density lipoproteins cholesterol, systolic blood pressure, bone mineral density, utility estimates relating to the individual's quality of life, and/or whether the individual has had diabetes, smokes, is currently receiving a growth hormone treatment drug, has ever received a growth hormone treatment drug, and/or has ever suffered any adverse conditions such as, but not limited to, myocardial infarction, coronary heart disease, stroke and/or bone fracture, such as hip or neck. As one of skill in the art will recognize, data stored in such a database 13 may be accessed and utilized by a computer system 11 in communication with the database 13. In an exemplary embodiment of the invention, the database may comprise Pharmacia International Metabolic Survey known as KIMS™, which contains information from over 5000 patients in 26 countries.

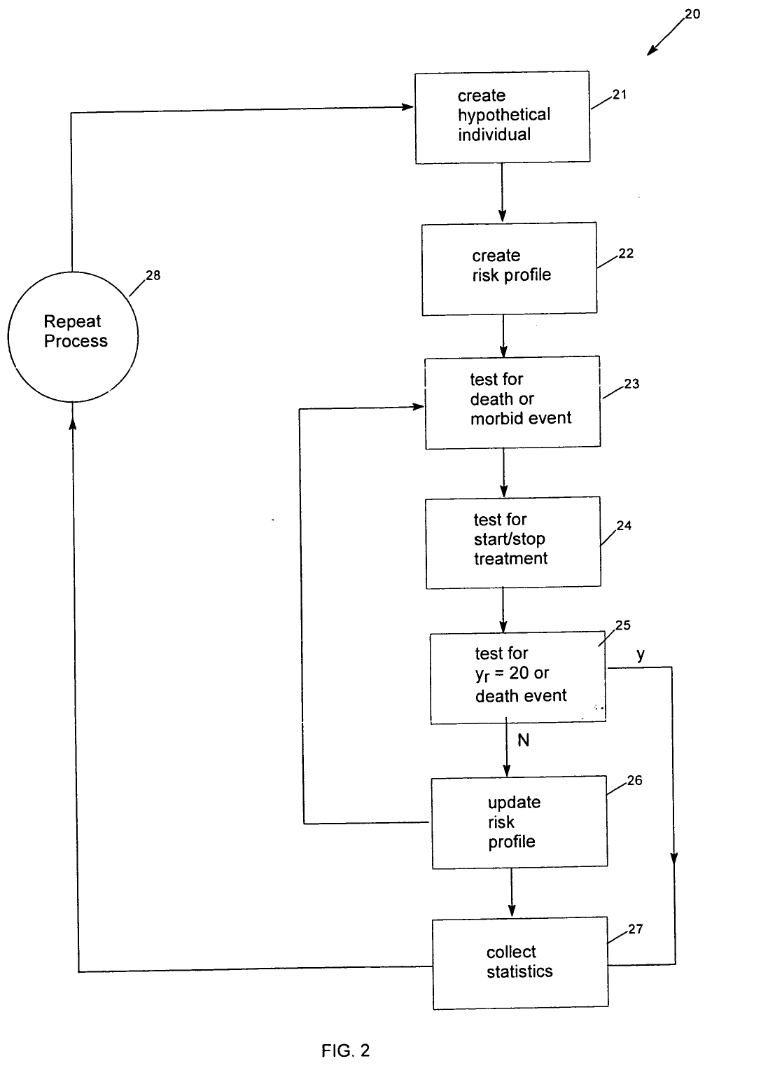

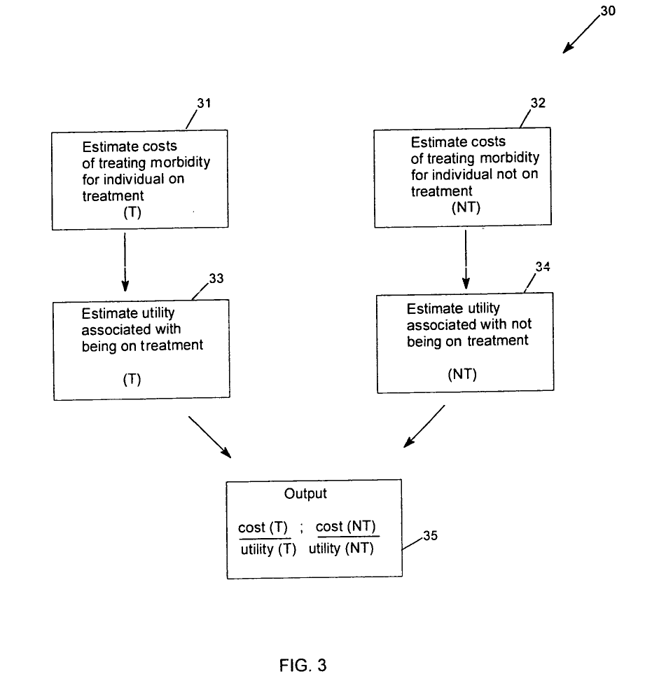

As described below, the method of determining and outputting a plurality of cost/utility estimates for evaluating the cost-effectiveness of providing growth hormone replacement treatment essentially comprises two-steps. First, as illustrated in FIG. 2, the system 10 comprises executable instructions configured to predict the development of one or more morbidities in an individual having growth hormone deficiency over a simulated life cycle. As used herein, the term “morbidities” is contemplated to mean adverse conditions associated with growth hormone deficiency such as, but not limited to, myocardial infarction, coronary heart disease, stroke and bone fracture such as hip or neck. In more detail, the system 10 is configured to simulate a life cycle of at least one individual, although in additional embodiments, the system is configured in one embodiment to simulate life cycles of tens, hundreds, thousands, ten thousands, hundred thousands or more individuals, and to predict how many of these individuals will be alive at the end of the life cycle, the frequency and types of morbidities each alive individual has developed, and number of individuals receiving treatment for growth hormone deficiency. Second, as illustrated in FIG. 3, the system 10 is configured with executable instructions to determine and output a plurality of cost/utility estimates associated with treating the predicted morbidities in patients having growth hormone deficiency based on the resulting predictions from the method described in FIG. 2. The output of the plurality of cost/utility estimates can subsequently be used to determine or evaluate the cost-effectiveness of providing growth hormone treatment therapy.

FIG. 2 depicts the first step of a method 20 comprising steps 21-28 for predicting how many hypothetical individuals will be alive at the end of a simulated life cycle, the frequency and types of morbidities each alive individual has developed, and number of individuals receiving treatment for growth hormone deficiency. As one of skill in the art will recognize, some or all of the steps of the method as depicted in FIG. 2 may be configured as executable instructions, for execution by a computer system 11 or on a CD ROM 15 configured to be executed by a computer system 11. The predictions resulting from this method might be outputted separately from the cost/utility estimates or might be considered an integral part of the overall methodology.

The method 20 comprises the step 21 of creating a hypothetical individual having randomly set baseline characteristics. In an exemplary embodiment of the invention, the baseline characteristics may include, but are not limited to, age, sex, smoking preference, total cholesterol, high density lipoproteins cholesterol, systolic blood pressure, bone mineral density, diabetes, and whether the individual is currently receiving a growth hormone treatment drug or has ever received a growth hormone treatment drug. The baseline characteristics may be generated by a random number generator configured within the computer system 11 and the numbers generated may be in accordance with averages found within database 13. For example, it is estimated that 19% of males and 21% of females having growth hormone deficiency also smoke. Accordingly, the system 11 could be configured such that if the hypothetical person is male there is a 19% chance that the hypothetical male will also smoke. Similarly, if the hypothetical person is female there is a 21% chance that the hypothetical female will also smoke.

The baseline characteristics are used to create a risk profile for the individual based on data from database 13 as illustrated in step 22. In an exemplary embodiment of the invention, the risk profile contains a set of probabilities that the hypothetical individual will develop a morbidity associated with growth hormone deficiency. In this context, the probability represents an estimate of an individual having growth hormone deficiency developing a particular morbidity during the simulated life cycle based on the baseline characteristics.

In one embodiment of the invention, a risk profile of a hypothetical individual may be based on data from database 13. For example, if the database 13 has 5000 records of individuals having growth hormone deficiency and 1000 of them have suffered from a bone fracture, then the probability of an individual having growth hormone deficiency developing a bone fracture is 20%. Based on this type of analysis, a probability may be determinable depending on any number of factors including, but not limited to, age, sex, and whether the individual is a smoker/non-smoker, has diabetes, or is being treated with a growth hormone treatment drug, and the like. In an another embodiment of the invention, the probabilities may be based on known risk equations and/or probability tables. For example, the probability of a death event occurring in any particular year may be based on life tables or based on the Framingham Risk Equation if the death was caused by coronary heart disease. The probability of an event other than a fracture occurring may also be based on the Framingham Risk Equation, and fracture events may be based on the Rotterdam Fracture Risk Equation which is known in the probability field.

Each hypothetical individual is progressed through a simulation in yearly increments and at each year, the risk profile is used to determine whether a death or morbid event occurs as illustrated in step 23. In determining the probability of a hypothetical individual developing any morbidity in any year of a simulated life, the computer system 11 may generate a random number between 0 and 1. The random number may then be compared against the probability that an event occurs in that year for an individual having growth hormone deficiency. If the random number is less than the event probability, then the event is deemed to have occurred in that year.

Additionally, as indicated in step 24, it is determined whether the individual started or stopped receiving growth hormone treatment. While it should be recognized that there are any number of ways to predict the probability of an individual starting or stopping treatment, for simplicity of the model, certain assumptions can be applied. First, it can be assumed that if an individual is currently on treatment and has been on treatment for more than three simulated years, then that individual will remain on treatment for the rest of the simulated life. Next, it can be assumed that if an individual is currently on treatment, but has not been on treatment for more than 3 years, the system 10 may test whether the individual comes off treatment. It should be recognized that the probability of a person coming off treatment after a particular period of time may be determined from database 13. Additionally, it can be assumed that if an individual is not currently on treatment and the individual previously had treatment, then the individual stays off treatment for the rest of the simulated life. Finally, it can be assumed that if the individual is not currently on treatment and the individual has not previously been on treatment, then the system may test whether the individual starts treatment. Once again, it should be recognized that the probability of a person starting treatment after a particular period of time may be determined from database 13. This describes one set of assumptions that may be employed based on database 13. Other assumptions regarding treatment regimes can be employed.

The system simulates the life cycle of an individual for 20 years unless a death event occurs as illustrated in step 25. For each year of the simulated life cycle, the probability of a particular morbid event occurring may change based on adjustments to the baseline values. For example, at each yearly iteration, age may be incremented by one-year, and systolic blood pressure, total cholesterol, high density lipoproteins cholesterol, and bone mineral density may be updated according to the individual's current age and whether the individual is currently receiving treatment. For an individual not on treatment, the risk profile may be changed, for example, only when an individual passes into a different age group. For example, data from the database 13 may indicate that individuals of age 31-54 have a higher chance of developing a morbidity than an 18-30 year old based on particular baseline factors. Accordingly, after each simulated year, the hypothetical individual's risk profile may be updated with new probabilities that represent the individual's probability of developing a morbidity associated with growth hormone deficiency in that year, as illustrated by step 26.

Upon completion of a simulated life or death event, statistics about the hypothetical individual are collected as depicted in step 27. The statistics collected from the simulation may include, but are not limited to, whether the hypothetical individual is alive, the frequency and types of morbidities the individual developed, and whether the individual is receiving treatment for growth hormone deficiency. These statistics are accumulated for each hypothetical individual that has a simulated life.

Finally, the process is repeated as illustrated in step 28 as many times as desired. In an exemplary embodiment of the invention, the process is repeated until 1000 hypothetical individual life simulations are simulated. Once 1000 individual simulated lives have been simulated, the whole process is typically repeated 300 times. Statistics collected from these simulations, or the results, show on average, how many individuals will be alive following the simulated life cycle, the frequency and types of morbidities each alive individual has developed such as the number of individuals having myocardial infarction, coronary heart disease, stroke or fracture, and number of individuals receiving treatment for growth hormone deficiency. As will be explained, these results can then be further analyzed in step-two of the model in terms of cost/utility estimation. The output 16 of the cost/utility estimates from this analysis may be used to determine and evaluate the cost effectiveness of providing growth hormone replacement therapy to individuals having growth hormone deficiency.

FIG. 3 depicts the second-step of a method 30 of determining and outputting a plurality of cost/utility estimates that may be used to evaluate the cost-effectiveness to providing growth hormone treatment therapy. The method 30 of FIG. 3 relies on the statistics collected, or results, from the method 20 described in FIG. 2. As mentioned, the results from the method implemented in FIG. 2 show on average, how many individuals will be alive, the frequency and types of morbidities each alive individual has developed, and number of individuals receiving treatment for growth hormone deficiency. These results can be further analyzed in terms of cost and utility to provide an output that may be used to evaluate the cost-effectiveness to providing growth hormone treatment therapy.

In more detail, the method 30 of FIG. 3 depicts the steps 31 and 32 of estimating the cost associated with treating the predicted developed morbidities, respectively, of an individual receiving treatment and of an individual not receiving treatment over the simulated life cycle. In step 31, the estimated cost associated with treating the predicted developed morbidities of individuals currently receiving treatment comprises the costs of the receiving the treatment as well as the hospital, physician and outpatient clinic costs. Similarly, in step 32, the estimated cost associated with treating the predicted developed morbidities of an individual not currently receiving treatment simply comprises the hospital, physician and outpatient clinic costs. In an exemplary embodiment of the invention, costs can be estimated using cost estimates from independent third-party organizations which may be stored in the database 13 in communication with the system, or may be stored on a CD-ROM 15.

As depicted in FIG. 3, utility estimates are also made for individuals receiving growth hormone therapy and for those not receiving therapy as depicted by steps 33 and 34, respectively. It is expected that individuals currently receiving growth hormone treatment therapy may have less complications and may develop less morbidities over the simulated life cycle than their counter parts not being treated with growth hormone treatment therapy. As a result, individuals being treated with growth hormone treatment therapy may accordingly have a better quality of life.

Estimate of the utilities for the treated and untreated groups associated with steps 33 and 34 can also be derived from data in database 13. As previously mentioned, third parties such as doctors may collect data relating to individuals having growth hormone deficiency which may be studied for medical and treatment purposes. One type of utility data collected may be via a questionnaire having yes/no questions designed to estimate the individual's perceived quality of life. The responses to the plurality of questions on the questionnaire may be quantified into a numeric utility score which represents the individual's quality of life. In an exemplary embodiment of the invention, a simple regression analysis may be used to convert the answers from the plurality of yes/no questions into a numeric utility score representing quality of life. These quality of life data as well as the utility scores may be stored in database 13.

While in an exemplary embodiment of the invention, the regression analysis may generate numeric utility scores ranging from 0-25, the range could theoretically be as small or large as desired. In the exemplary embodiment, the utility scores of individuals are categorized in subcategories ranging from low utility scores, which represent high quality of life, to high utility scores, which represent a low quality of life, such as, for example, 0-5, 6-10, 11- 15 and 16-25. Accordingly, a numeric utility score in the 0-5 range indicates that the individual has a high quality of life, and score from 16-25 represents a low quality of life.

It should be recognized that the baseline utility scores from both the treated and untreated groups should be the same. However, after receiving treatment the first and/or subsequent years, the utility scores for the treated group should be better (or lower) than those of the baseline utilities. To estimate the utility for the treated and untreated groups as depicted in steps 33 and 34, the utility scores from the database 13 were used to construct utility profiles. While it should be recognized that the utility profiles could be constructed in an number of ways, in one embodiment of the invention a conservative approach was taken to estimate the utilities of steps 33 and 34 to provide conservative analysis of the cost/utility estimates.

In this embodiment, it can be assumed that the utility of the individuals receiving treatment remains constant and without any deterioration for the 20 year life simulation. For model simplification purposes, it can also assumed that the utility estimates from treatment from the first year are used as the utility estimates. Accordingly, the estimate of the utility associated with receiving growth hormone treatment therapy can be derived directly from data in database 13 (i.e. step 33).

Additionally, to estimate the utility associated with not receiving growth hormone treatment, it can be assumed that the untreated group has a utility that is sustained for 20 years without any deterioration at the baseline values. Accordingly, the estimate of the utility associated with not receiving growth hormone treatment therapy can also be derived directly from data in database 13 (i.e. step 34).

In another embodiment, the utility profiles may be constructed according to an intuitive approach. In this embodiment, it is assumed that the utility of the individuals receiving treatment remains constant and without any deterioration for the 10 years of the life simulation followed by deterioration in quality of life for a five year period and then followed by a stabilization thereafter. In this embodiment, the utility associated with receiving growth hormone treatment therapy may be derived directly from the database 13 if such data is available, or may be calculated using regression analysis or other calculations (i.e. step 33).

Similarly, it can be assumed for the untreated group that utility deteriorates immediately from the baseline for a period of years, such as 5 years, followed by a stabilization thereafter. Once again, in this embodiment, the utility associated with not receiving growth hormone treatment therapy may be derived directly from the database 13 if such data is available, or may be calculated using regression analysis or other calculations (i.e. step 33).

Step 35 indicates that the system 10 outputs a plurality of cost/utility estimates. For example, the system 10 may output a cost(T)/utility(T) associated with receiving growth hormone treatment therapy and a cost(NT)/utility(NT) associated with not receiving growth hormone treatment therapy. Accordingly, the plurality of cost/utility estimates may be used to evaluate the cost-effectiveness of providing growth hormone treatment therapy. For example, the incremental change in cost divided by incremental change in utility should provide an estimate of the cost per quality adjusted life year, where cost per life adjusted year is contemplated to mean the cost associated with improving the quality of life of an individual have growth hormone deficiency. Finally, it should be recognized that the output 35 (i.e. cost (T)/utility (T) and cost (NT)/utility (NT)) of the system 10 may be compared to evaluate the cost-effectiveness of providing the treatment to the individuals having growth hormone deficiency.

From the foregoing, it should be recognized that the system and method of determining and outputting a plurality of cost/utility estimates can be easily modified to research and target specific groups of individuals having growth hormone deficiency. For example, the above cost/utility estimates could be further subdivided in terms of age, sex, smoking preference and the like. Similarly, depending on, for example, a researcher's particular desires, the model may be modified to test for treatments associated with particular utility score, for treatment within a particular subcategory, or for individuals having risks of coronary heart disease, stroke, fracture or the like.

Having shown and described the embodiments of the present invention, further adaptations of the present invention as described herein can be accomplished by appropriate modifications by one of ordinary skill in the art without departing from the scope of the present invention. Several of these potential modifications and alternatives have been mentioned, and others will be apparent to those skilled in the art. For example, while exemplary embodiments of the system have been discussed for illustrative purposes, it should be understood that the elements described will be constantly updated and improved by technological advances. Accordingly, the scope of the present invention should be considered in terms of the following claims and is understood not to be limited to the details of structure, operation or process steps as shown and described in the specification and drawings.

We claim:

1. A method of determining a plurality of cost/utility estimates for evaluating the cost effectiveness of providing growth hormone replacement therapy to an individual having growth hormone deficiency, the method comprising the steps of:
a) identifying one or more morbidities associated with growth hormone deficiency;
b) predicting the development of the one or more morbidities in an individual being treated with growth hormone replacement therapy over a simulated life cycle;
c) estimating a cost associated with providing growth hormone replacement therapy and with treating the predicted developed one or more morbidities in the individual being treated with growth hormone replacement therapy over the simulated life cycle;
d) estimating a utility associated with being treated with growth hormone replacement therapy;
e) predicting the development of the one or more morbidities in an individual not being treated with growth hormone replacement therapy over a simulated life cycle;
f) estimating a cost associated with treating the predicted developed one or more morbidities in the individual not being treated with growth hormone replacement therapy over the simulated life cycle; and
g) estimating a utility with not being treated with growth hormone replacement therapy.

2. The method of claim 1, wherein the step of predicting the development of one or more morbities includes setting a plurality of baseline values for the individual that identify a corresponding plurality of predetermined risk factors about the individual.

3. The method of claim 2, wherein the baseline values comprise systolic blood pressure, diabetes, total cholesterol, high density lipoproteins choiesteroi, bone mineral density, age, sex, smoking preference, whether the individual is currently receiving growth hormone treatment therapy or has ever received growth hormone treatment therapy, or combinations thereof.

4. The method of claim 1, wherein the utility is derived from the individual's answers to a pre-determined set of questions.

5. The method of claim 1, wherein the step of predicting the development of one or more morbidities includes predicting a risk of death of the individual.

6. The method of claim 5, wherein the risk of death is based on natural death tables, coronary heart disease tables, or both.

7. The method of claim 2, wherein the step of predicting the development of one or more morbidities includes applying the risk factors to predict development of the one or more morbidities during the simulated life cycle.

8. The method of claim 1, wherein the morbidities comprise myocardial infarction, coronary heart disease, stroke, hip fracture, neck fracture, death or combinations thereof.

9. The method of claim 1, wherein the step of predicting the development of one or more morbidities includes applying a risk equation, probability table or combination thereof to determine a probability of developing myocardial infarction, coronary heart disease, stroke, hip fracture and neck fracture.

10. The method of claim 9, wherein the step of predicting the development of one or more morbidities includes applying a Framingham Risk Equation to determine a probability of developing myocardial infarction or coronary heart disease.

11. The method of claim 9, wherein the step of predicting the development of one or more morbidities includes applying a Rotterdam fracture risk equation to determine a probability of developing a hip fracture.

12. The method of claim 1, wherein cost is estimated from the cost of hospital visits, outpatient clinics, physician visits, growth hormone replacement therapy, or combinations thereof.

13. The method of claim 1, wherein the life cycle of the individual is simulated for a period of 20 years.

14. The method of claim 1, further comprising the step of outputting the estimated cost and estimated utility associated with the individual being treated with growth hormone replacement therapy and the estimated cost and estimated utility associated with the individual not being treated with growth hormone replacement therapy.

15. The method of claim 14, further comprising the step of comparing the output to evaluate the cost-effectiveness of providing the treatment to the individual having growth hormone deficiency.

16. A computer-readable medium containing instructions for outputting a plurality of cost/utility estimates for evaluating the cost effectiveness of providing growth hormone replacement therapy to an individual having growth hormone deficiency; the instructions being operable to:
a) predict the development of one or more predetermined morbidities in an individual being treated with growth hormone replacement therapy over a simulated life cycle;
b) estimate a cost associated with providing growth hormone replacement therapy and with treating the predicted developed one or more morbidities in the individual being treated with growth hormone replacement therapy over the simulated life cycle;
c) estimate a utility associated with being treated with growth hormone replacement therapy;
d) predict the development of the one or more predetermined morbidities in an individual not being treated with growth hormone replacement therapy over a simulated life cycle;
e) estimate a cost associated with treating the predicted developed one or more morbidities in the individual not being treated with growth hormone replacement therapy over the simulated life cycle;
f) estimate a utility associated with not being treated with growth hormone replacement therapy; and
g) output the estimated cost and estimated utility associated with the individual being treated with growth hormone replacement therapy and the estimated cost and estimated utility associated with the individual not being treated with growth hormone replacement therapy.

17. The computer readable medium of claim 16, further comprising instructions configured to provide an output that predicts the number of individuals with growth hormone deficiency that develop myocardial infarction, the number of individuals with growth hormone deficiency that develop coronary heart disease, the number of individuals with growth hormone deficiency that develop stroke, the number of individuals with growth hormone deficiency that develop hip fracture, the number of individuals with growth hormone deficiency that develop neck fractures, the number of individuals with growth hormone deficiency that are alive and the number of individuals with growth hormone deficiency that are receiving treatment, or any combination thereof.

18. A system for outputting a plurality of cost/utility estimates for determining the cost effectiveness of providing growth hormone replacement therapy to an individual having growth hormone deficiency, the system comprising:
a database comprising:
data identifying one or more morbidities associated with growth hormone deficiency;
data identifying a probability of developing the one or more morbidities;
data identifying a cost associated with treating the one or more morbidities;
data identifying a cost associated with providing growth hormone treatment therapy;
data identifying a utility associated with receiving growth hormone treatment therapy; and
data identifying a utility associated with not receiving growth hormone treatment therapy; and
a computer system comprising executable instructions in communication with the database and configured to predict the development of one or more morbidities over a simulated life cycle, and further comprising executable instructions configured to output a plurality of cost/utility estimates based on the data.

19. The system of claim 18, wherein the database further comprises a plurality of baseline values for the individual that identify a corresponding plurality of predetermined risk factors about the individual.

20. The system of claim 18, wherein data identifying the probability of developing the one or more morbidities is derived using a risk equation, probability table or combination thereof.
